(19) United States
(12) Patent Application Publication
(10) Pub. No.: US 2019/0285214 A1
(43) Pub. Date: Sep. 19, 2019

(54) SOLENOID VALVE QUICK-CONNECTING STRUCTURE

(71) Applicant: CHENG CHANG YANG, CHANGHUA COUNTY (TW)

(72) Inventor: CHENG CHANG YANG, CHANGHUA COUNTY (TW)

(21) Appl. No.: 16/430,648

(22) Filed: Jun. 4, 2019

Related U.S. Application Data
(63) Continuation of application No. 15/923,331, filed on Mar. 16, 2018.

(30) Foreign Application Priority Data
Mar. 20, 2017 (TW) 106109158
Mar. 22, 2019 (TW) 108203512

(51) Int. Cl. F16L 37/092; F16L 37/091; F16K 27/02; E03C 1/02

(52) U.S. Cl. CPC F16L 37/0925; E03C 1/021; F16K 27/02; F16L 37/091

(57) ABSTRACT

A solenoid valve quick-connecting structure includes a main body having a three-way channel therein. A surface of the main body is formed with a first connecting opening, a second connecting opening and a third connecting opening. At least one of the first connecting opening and the second connecting opening is provided with an accommodating chamber. The accommodating chamber has a reduced section and an enlarged section. The enlarged section is connected to one side of the reduced section, distant from the first connecting opening or the second connecting opening. The accommodating chamber is provided with a positioning clamp that has an annular base and spaced clamping blocks. The clamping blocks are deformable through a gap defined between every adjacent two of the clamping blocks for clamping an external pipe. A solenoid valve body is disposed at the third connecting opening for opening or closing the three-way channel according to an electronic signal.

This Application is being filed as a Continuation-in-Part of U.S. patent application Ser. No. 15/923,331, filed Mar. 16, 2018, currently pending.

### FIELD OF THE INVENTION

The present invention relates to a quick-connecting structure, and more particularly to a solenoid valve quick-connecting structure.

### BACKGROUND OF THE INVENTION

In order to control the flow rate of the water flow or the water supply, the flow channel is provided with a control valve. With the advance of science and technology, a solenoid valve is developed on the market. The solenoid valve is automatically controlled by electronic signals. A conventional solenoid valve has two connecting openings on both sides for connecting two pipes, respectively. The water flow can flow along the pipes through the solenoid valve, and the opening and closing of the solenoid valve can control the water flow.

In general, the connecting opening of the conventional solenoid valve is provided with threads for connecting the pipe, so the pipe is also provided with threads. The installer needs a tool to lock the pipe to the connecting opening in a rotating manner. In order to prevent the pipe from being loosed, it is necessary to provide other auxiliary fixing means. For example, thread seal tape is wrapped around the threads. This will increase the cumbersome installation of the solenoid valve and take a lot of time and effort.

### SUMMARY OF THE INVENTION

The primary object of the present invention is to provide a solenoid valve quick-connecting structure. A flexible positioning clamp is used to engage with a pipe to be connected without additional components, thereby reducing the number of components and simplifying the operation.

In order to achieve the above object, the present invention provides a solenoid valve quick-connecting structure. The solenoid valve quick-connecting structure comprises a main body, a solenoid valve body, and a positioning clamp. The main body has a three-way channel therein. A surface of the main body is formed with a first connecting opening, a second connecting opening and a third connecting opening. At least one of the first connecting opening and the second connecting opening is provided with an accommodating chamber. The accommodating chamber has a reduced section and an enlarged section that has an inner diameter greater than that of the reduced section. The enlarged section is connected to one side of the reduced section, distant from the first connecting opening or the second connecting opening. The solenoid valve body is disposed at the third connecting opening for opening or closing the three-way channel according to an electronic signal. The positioning clamp is disposed in the accommodating chamber. The positioning clamp has an annular base. The positioning clamp has a plurality of clamping blocks that extend from one side of the base and are spaced apart from each other. The clamping blocks correspondingly extend to the enlarged section. The clamping blocks are slightly deformable through a gap defined between every adjacent two of the clamping blocks for clamping an external pipe.

In an embodiment, the accommodating chamber is provided with a tubular support member communicating with the three-way channel. The external pipe is sleeved on the tubular support member to be clamped and positioned on the tubular support member through the positioning clamp.

In an embodiment, the inner diameter of the enlarged section gradually increases in a direction opposite to the first connecting opening or the second connecting opening.

In an embodiment, another side of the reduced section, close to the first connecting opening or the second connecting opening, is connected to a guiding section. An inner diameter of the guiding section gradually increases toward the first connecting opening or the second connecting opening.

In an embodiment, an inner side of each of the clamping blocks is provided with a toothed portion.

In an embodiment, an outer side of each of the clamping blocks is provided with a protruding portion. The positioning clamp has an outer diameter defined by a distance between outer edges of the protruding portions of the clamping blocks. The outer diameter of the positioning clamp is greater than the inner diameter of the reduced section.

In an embodiment, the accommodating chamber is provided with at least one annular groove, and the annular groove is provided with a sealing ring.

### BRIEF DESCRIPTION OF THE DRAWINGS

FIG. 1 is an exploded view of the present invention;

FIG. 2 is a cross-sectional view of the present invention; and

FIG. 3 is a schematic view of the present invention when in use.

### DETAILED DESCRIPTION OF THE PREFERRED EMBODIMENTS

Embodiments of the present invention will now be described, by way of example only, with reference to the accompanying drawings.

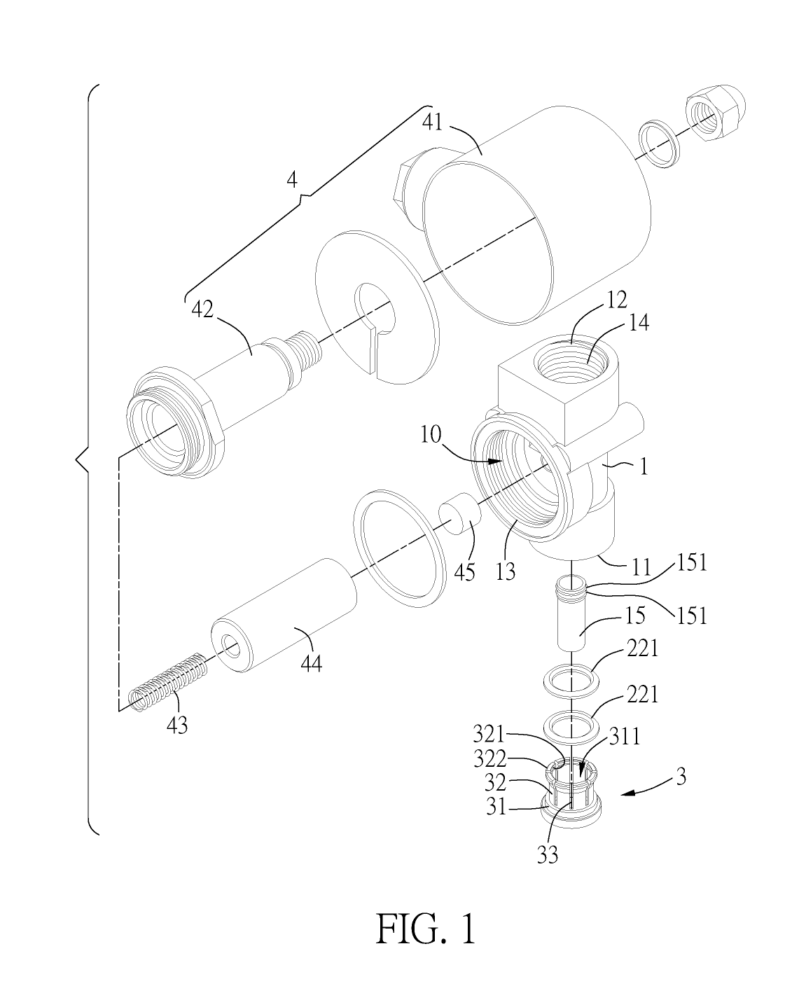

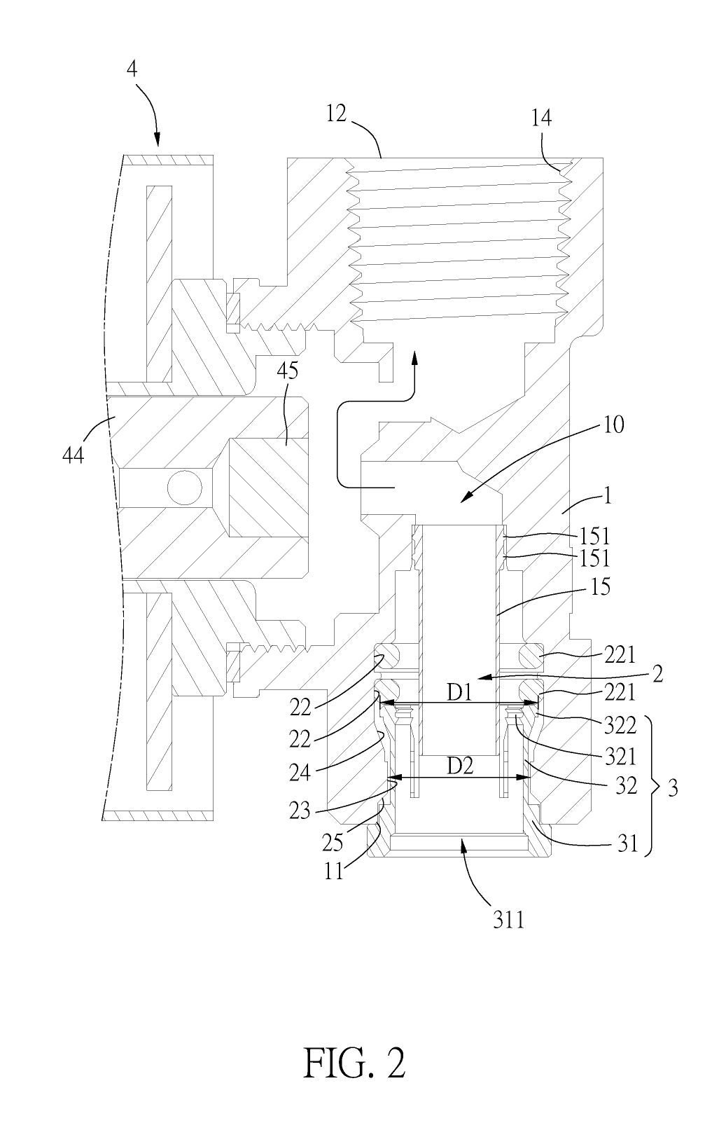

Referring to FIG. 1 and FIG. 2, the present invention discloses a solenoid valve quick-connecting structure. The solenoid valve quick-connecting structure comprises a main body 1 having a T-shaped three-way channel 10 therein. The surface of the main body 1 is formed with a first connecting opening 11, a second connecting opening 12 and a third connecting opening 13. The first connecting opening 11 and the second connecting opening 12 are located on opposite sides of the main body 1 for connecting an external pipe. The third connecting opening 13 is located on another side of the main body 1 for connecting a solenoid valve body 4. The solenoid valve body 4 includes a housing 41, an iron core 42, a spring 43, a piston 44 and the like. One end of the piston 44, facing the three-way channel 10, is provided with a water-blocking block 45. The piston 44 can be driven to generate displacement according to an electronic signal, thereby enabling the water-blocking block 45 to open or close the three-way channel 10 so as to control the water flow.

The quick-connecting structure of the present invention is disposed in one of the first connecting opening 11 and the second connecting opening 12, and the other, without the quick-connecting structure of the present invention, may be in the form of a threaded hole. However, both the first connecting opening 11 and the second connecting opening 12 may be provided with the quick-connecting structure of the present invention. In this embodiment, the first connecting opening 11 is provided with the quick-connecting structure, and the second connecting opening 12 is in the form of a threaded hole 14 as an example.

The main body 1 is concavely formed with an accommodating chamber 2 close to the first connecting opening 11. At least one annular groove 22 is disposed in the accommodating chamber 2. The annular groove 22 is provided with a sealing ring 221. Hence, when the external pipe is inserted into the accommodating chamber 2, the external pipe is enclosed by the sealing ring 221 to perform sealing. The accommodating chamber 2 has a reduced section 23 close to the first connecting opening 11. One side of the reduced section 23, distant from the first connecting opening 11, is connected to an enlarged section 24 that has an inner diameter greater than that of the reduced section 23. The inner diameter of the enlarged section 24 gradually increases in a direction opposite to the first connecting opening 11. Furthermore, another side of the reduced section 23, close to the first connecting opening 11, is connected to a guiding section 25. The inner diameter of the guiding section 25 gradually increases toward the first connecting opening 11.

The accommodating chamber 2 is provided with a positioning clamp 3 for positioning the external pipe. The positioning clamp 3 has a base 31 in an annular shape to surround a passage 311. The positioning clamp 3 has a plurality of clamping blocks 32 extending from one side of the base 31. The clamping blocks 32 surround the passage 311 of the base 31 and are spaced apart from each other by gaps 33. Through the gaps 33, the clamping blocks 32 can be slightly deformed after being applied with a force. The inner side of each of the clamping blocks 32 is provided with a toothed portion 321 for clamping the external pipe stably. The outer side of each of the clamping blocks 32 is provided with a protruding portion 322. The positioning clamp 3 has an outer diameter D1 defined by the distance between the outer edges of the protruding portions 322 of the clamping blocks 32. The outer diameter D1 of the positioning clamp 3 is greater than the inner diameter D2 of the reduced section 23.

When assembled, the positioning clamp 3 is inserted into the accommodating chamber 2 from the first connecting opening 11. In detail, because the outer diameter D1 of the positioning clamp 3 is greater than the inner diameter D2 of the reduced section 23, the protruding portions 322 of the clamping blocks 32 of the positioning clamp 3 are first pressed against the guiding section 25. During placing the positioning clamp 3 into the accommodating chamber 2, the clamping blocks 32 are guided by the guiding section 25 to come close to each other, thus the outer diameter D1 of the positioning clamp 3 is temporarily reduced to allow the positioning clamp 3 to enter the reduced section 23. After the clamping blocks 32 pass through the reduced section 23 to enter the enlarged section 24, the clamping blocks 32 are no longer compressed to restore its original shape. Since the outer diameter D1 of the positioning clamp 3 is again greater than the inner diameter D2 of the reduced section 23, the positioning clamp 3 is engaged in the accommodating chamber 2.

In addition, the accommodating chamber 2 is provided with a tubular support member 15 communicating with the three-way channel 10. One end of the tubular support member 15 is provided with two sealing rings 151 that are tightly pressed against the inner wall of the three-way channel 10 to provide the function of preventing leakage. The tubular support member 15 extends into the passage 311 of the positioning clamp 3 and is spaced from the clamping blocks 32.

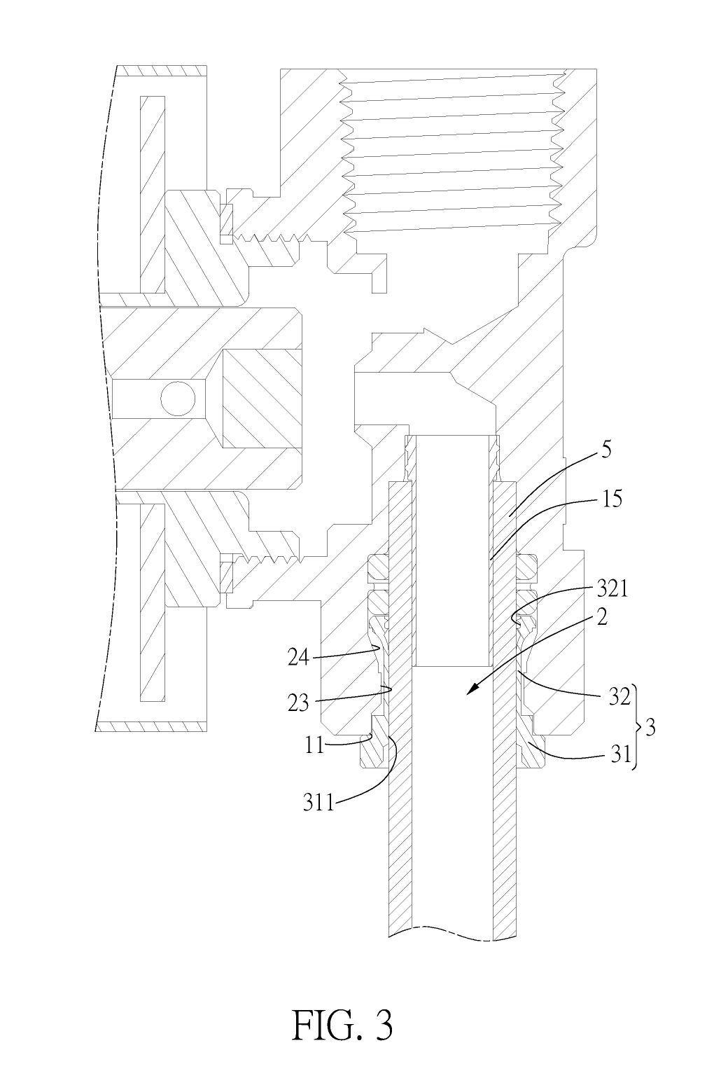

With the above structure, when an external pipe is to be connected to the present invention, as shown in FIG. 3, the external pipe 5 passes through the passage 311 of the base 31 of the positioning clamp 3 from the first connecting opening 11 to be inserted into the accommodating chamber 2 and sleeved onto the outer circumference of the tubular support member 15. At the same time, the clamping blocks 32 are expanded outwardly in the space of the enlarged section 24 by the external pipe 5, and the external pipe 5 is clamped by the clamping blocks 32 after restored, so that the external pipe 5 is positioned. Furthermore, the external pipe 5 is fastened by the toothed portions 321 of the clamping blocks 32 to generate larger frictional resistance, so that the external pipe 5 is connected to the first connecting opening 11 of the main body 1 more firmly.

As above, it can be understood that the advantage of the present invention is that when the external pipe 5 is inserted into the first connecting opening 11, the external pipe 5 is expanded outwardly via the tubular support member 15 inside the external pipe 5, and the positioning clamp 3 automatically clamps the external pipe 5 to obtain a tight positioning effect. The operation is very simple, convenient and time-saving, thereby facilitating the assembly of the pipe fitting of the solenoid valve.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A solenoid valve quick-connecting structure, comprising:
a main body, having a three-way channel therein, a surface of the main body being formed with a first connecting opening, a second connecting opening and a third connecting opening; at least one of the first connecting opening and the second connecting opening being provided with an accommodating chamber, the accommodating chamber having a reduced section and an enlarged section that has an inner diameter greater than that of the reduced section, wherein the enlarged section is connected to one side of the reduced section, distant from the first connecting opening or the second connecting opening;
a solenoid valve body, disposed at the third connecting opening, for opening or closing the three-way channel according to an electronic signal;
a positioning clamp, disposed in the accommodating chamber; the positioning clamp having an annular base, the positioning clamp having a plurality of clamping blocks that extend from one side of the base and are spaced apart from each other; the clamping blocks correspondingly extending to the enlarged section; wherein the clamping blocks are slightly deformable through a gap defined between every adjacent two of the clamping blocks for clamping an external pipe.

2. The solenoid valve quick-connecting structure as claimed in claim 1, wherein the accommodating chamber is provided with a tubular support member communicating with the three-way channel; and the external pipe is sleeved on the tubular support member to be clamped and positioned on the tubular support member through the positioning clamp.

3. The solenoid valve quick-connecting structure as claimed in claim 1, wherein the inner diameter of the enlarged section gradually increases in a direction opposite to the first connecting opening or the second connecting opening.

4. The solenoid valve quick-connecting structure as claimed in claim 1, wherein another side of the reduced section, close to the first connecting opening or the second connecting opening, is connected to a guiding section, and an inner diameter of the guiding section gradually increases toward the first connecting opening or the second connecting opening.

5. The solenoid valve quick-connecting structure as claimed in claim 1, wherein an inner side of each of the clamping blocks is provided with a toothed portion.

6. The solenoid valve quick-connecting structure as claimed in claim 1, wherein an outer side of each of the clamping blocks is provided with a protruding portion, the positioning clamp has an outer diameter defined by a distance between outer edges of the protruding portions of the clamping blocks, and the outer diameter of the positioning clamp is greater than the inner diameter of the reduced section.

7. The solenoid valve quick-connecting structure as claimed in claim 1, wherein the accommodating chamber is provided with at least one annular groove, and the annular groove is provided with a sealing ring.
